(19) United States
(12) Patent Application Publication
(10) Pub. No.: US 2003/0118734 A1
(43) Pub. Date: Jun. 26, 2003

(54) Coil coating method using powder coat dispersions (powder slurries)

(76) Inventors: Lothar Jandel, Munster (DE); Hans-Joachim Weintz, Senden (DE); Joachim Woltering, Munster (DE); Geoffrey Dodd, Darwen (GB)

Correspondence Address: BASF CORPORATION, ANNE GERRY SABOURIN, 26701 TELEGRAPH ROAD, SOUTHFIELD, MI, 48034-2442, US

(21) Appl. No.: 10/257,927

(22) PCT Filed: Jun. 1, 2001
(86) PCT No.: PCT/EP01/06226

(51) Int. Cl. B05D 1/40

(52) U.S. Cl. 427/372.2; 427/331

(57) ABSTRACT

A coil coating process in which a metal strip is coated continuously on one or two sides with at least one coating material and then the applied coating film(s) is (are) cured, at least one of the coating materials being a pigmented or unpigmented powder coating dispersion (powder slurry) and the applied powder slurry film(s) being heated so that

(i) the water present therein evaporates,

(ii) the finely divided dimensionally stable constituents of the powder slurry which remain melt and coalesce, and

(iii) curing is carried out thermally and/or with actinic radiation, to give at least one clearcoat and/or at least one color and/or effect coat.

The present invention relates to a novel coil coating process which is conducted using powder coating dispersions.

Coil coating is the term used for a special form of roller coating (Römpp Lexikon Lacke und Druckfarben, Georg Thieme Verlag, Stuttgart, New York, 1998, page 617, “Roller coating”) and also, occasionally, the spray and flow coating of metal strips with liquid coating materials. It comprises a continuous process, i.e., all operations such as cleaning, pretreatment, painting and curing, etc., are conducted in one operation in one installation. Schematically, the steps involved in coil coating are as follows: following cleaning and degreasing of the strip, there is a multistage chemical pretreatment with subsequent passivation, rinsing, and drying. After cooling, the liquid coating material is applied to one or two sides using two or three rolls, usually by the reverse roller coating technique. After a very short evaporation time, the applied coat is thermally cured at temperatures from 180 to 260° C. for from 10 to 60 s. For the production of a multicoat system, application and curing are repeated. The speeds of coil coating lines are up to 250 m/min (Römpp Lexikon Lacke und Druckfarben, Georg Thieme Verlag, Stuttgart, New York, 1998, page 55, “Coil coating”).

The liquid coating materials used to date for coil coating, however, lead to considerable emissions of organic solvents, which economically and environmentally is no longer acceptable.

Attempts have therefore been made to replace the conventional coil coating materials by solvent-free powder coating materials. In relation to the liquid coating materials it is a disadvantage, however, that the necessary powder coating thicknesses are very high. They are in fact between 40 and 50 μm. If the powder coating materials are applied more thinly, the coating is no longer pore-free. This leads to optical defects and sites for corrosive attack.

German Patent Application DE 196 32 426 A1 discloses a coil coating process using a very fine powder coating material with very narrow particle size distribution, which permits the production of pore-free coatings with a dry film thickness of less than 10 μm. A disadvantage is that the preparation of the very fine powder coating material is comparatively difficult.

Generally, coil coating with powder coating materials has the disadvantage of the need to use special application installations such as electrostatic powder spraying units in the case of slow-moving coils or so-called powder cloud chambers in the case of fast-moving coils.

German Patent Applications DE 199 08 013.5, DE 199 20 141.2, DE 199 08 018.6 and DE 100 01 442.9, unpublished at the priority date of the present specification, propose using pigmented and unpigmented powder slurries for coil coating. How this is to be done in detail, however, is not described.

It is an object of the present invention to find a new coil coating process from which the disadvantages of the prior art are absent and which, instead, combines the advantages of coil coating with liquid coating materials, on the one hand, and the advantages of coil coating with powder coating materials, on the other, and which even with thin coat thicknesses gives pore-free coatings with excellent adhesion to the coil, excellent intercoat adhesion, very good optical and mechanical properties, and, in particular, excellent deformability, all without the emission of organic solvents.

Accordingly, we have found the novel coil coating process, in which a metal strip is coated continuously on one or two sides with at least one coating material and then the applied coating film(s) is (are) cured, at least one of the coating materials being a pigmented or unpigmented powder coating dispersion (powder slurry) and the applied powder slurry film(s) being heated so that

(i) the water present therein evaporates,

(ii) the finely divided dimensionally stable constituents of the powder slurry which remain melt and coalesce, and

(iii) curing is carried out thermally and/or with actinic radiation, to give at least one clearcoat and/or at least one color and/or effect coat.

In the text below, the novel coil coating process is referred to as the “process of the invention”.

Further subject matter of the invention will emerge from the description.

In the context of the present invention, the term “color and/or effect coat” embraces both achromatic (cf. Römpp Lexikon Lacke und Druckfarben, Georg Thieme Verlag, 1998, page 590, “Achromatic point”) and chromatic, i.e., colored, multicoat systems.

The process of the invention starts from a metal strip (“coil”) which has been conventionally cleaned, degreased, passivated, chemically treated, rinsed and dried and also, optionally, provided on one or two sides with at least one coating film or with a primer or with at least one single-coat or multicoat system.

Suitable metals are all those from which it is possible to form strips which are up to the mechanical, chemical and thermal stresses of coil coating. Highly suitable metal strips are those based on aluminum or iron. In the case of iron, cold-rolled steels, electrolytically zinc-plated steels, hot-dip galvanized steels, or stainless steels are especially suitable. Preferably, the strips have a thickness of from 200 μm to 2 mm.

For coil coating, the metal strip passes through a coil coating line, as is described, for example, in Römpp Lexikon Lacke und Druckfarben, Georg Thieme Verlag, Stuttgart, New York, 1998, page 55, “Coil coating”, or in German Patent Application DE 196 32 426 A1, at a speed adapted to the application and curing properties of the coating materials, especially the powder slurries, employed in the process of the invention. The speed may therefore vary very widely from one coating process to another. It is preferably from 10 to 150, more preferably from 12 to 120, with particular preference from 14 to 100, with very particular preference from 16 to 80, and in particular from 20 to 70 m/min.

The pigmented and unpigmented powder slurries to be used in accordance with the invention and described in detail below, and any other coating materials used, may be applied in any desired manner, for example, by spraying, flow coating or roller coating. Of these application techniques, roller coating is particularly advantageous and is therefore used with preference in accordance with the invention.

Each application step in roller coating may be conducted using two or more rolls. Preference is given to the use of from two to four, and especially two, rolls.

In roller coating, the rotating pick-up roll dips into a powder slurry reservoir and so picks up the powder slurry for application. This slurry is transferred directly by the pick-up roll, or via at least one transfer roll, to the rotating application roll. From this latter roll, the powder slurry is transferred onto the strip by means of co-directional or counter-directional contact transfer.

Alternatively, the powder slurry may be pumped directly into a gap between two rolls, which is referred to in the art as nip feed.

In accordance with the invention, counter-directional contact application, or the reverse roller coating technique, is advantageous and is therefore employed with preference.

In roller coating, the peripheral speeds of the pick-up roll and the application roll may vary very greatly from one coating process to another. Preferably, the application roll has a peripheral speed which is from 110 to 125% of the strip speed and the pick-up roll has a peripheral speed which is from 20 to 40% of the strip speed.

The powder slurries are preferably applied in a wet film thickness such that curing of the powder slurry films results in clearcoats and/or color and/or effect coats with a dry film thickness of from 5 to 100, preferably from 6 to 80, with particular preference from 8 to 70, with very particular preference from 10 to 60, and in particular from 12 to 50 μm.

The application methods described above may be employed in connection with the other coating materials, if used, unless these other coating materials comprise powder coating materials, in which case the application methods specified at the outset must be used.

Examples of suitable other coating materials are conventional pigmented and unpigmented coating materials such as primers based on polyester and/or epoxide, basecoats, especially aqueous polyurethane-based basecoats, and/or clearcoats such as aqueous and nonaqueous one-component clearcoats or two-component or multicomponent clearcoats.

Examples of suitable coatings produced from these materials are primer coats, color and/or effect basecoats, or clearcoats.

In the context of the process of the invention, the powder slurry or slurries is or are preferably

(i) applied directly to the strip and cured,

(ii) applied to at least one single-coat or multicoat system present on the strip, and cured, or

(iii) applied wet-on-wet to at least one single-coat or multicoat film present on the strip, and the coating film(s) and the powder slurry film(s) are cured conjointly,

or

(iv) the cured or uncured powder slurry film(s) is (are) coated with at least one coating material, after which the resultant coating film(s) is(are) cured alone or together with the powder slurry film(s).

Irrespective of which preferred variant of the process of the invention is chosen, it is essential that the powder slurry film(s) is (are) heated such that

(i) the water present therein evaporates,

(ii) the finely divided dimensionally stable constituents of the powder slurry which remain melt and coalesce, and

(iii) curing is carried out thermally and/or with actinic radiation, to give at least one clearcoat and/or at least one color and/or effect coat.

This is realized by means of a preset temperature program which is adapted to the drying rate, melting range and, if appropriate, the temperature range of the curing of the powder slurry used in each case. These parameters, in turn, are dependent primarily on the material composition of the respective powder slurry. The temperature program may therefore vary very widely from one powder slurry to another, but may easily be inferred by the skilled worker on the basis of the known relationships between material composition and the stated parameters.

The heating may take place by convective heat transfer, irradiation with near or far infrared, and/or, in the case of iron-based strips, by means of electrical induction. The maximum object temperature is preferably 250° C.

The heating time, i.e., the duration of thermal curing, varies depending on the powder slurry used. Preferably, it is from 10 s to 2 min.

If use is made essentially of convective heat transfer, convection ovens with a length of from 30 to 50 m, in particular from 35 to 45 m, are required at the preferred strip running speeds.

The thermal curing of the powder slurries may also be assisted by exposure to actinic radiation.

Alternatively, curing may take place with actinic radiation alone, as is described, for example, in German Patent Application DE 198 35 206 A1.

In the context of the present invention, actinic radiation comprises electromagnetic radiation, such as near infrared (NIR), visible light, UV radiation or x-rays, especially UV radiation, and corpuscular radiation such as electron beams.

If thermal curing and curing with actinic light are employed conjointly in a powder slurry, the terms “dual cure” and “dual-cure powder slurry” are also used.

In the case of curing with actinic radiation, it is preferred to employ a dose of from 1000 to 3000, preferably from 1100 to 2900, with particular preference from 1200 to 2800, with very particular preference from 1300 to 2700, and in particular from 1400 to 2600 mJ/cm². If desired, this curing may be supplemented by actinic radiation from other radiation sources. In the case of electron beams, it is preferred to operate under an inert gas atmosphere. This can be ensured, for example, by supplying carbon dioxide and/or nitrogen directly to the surface of the powder slurry film. In the case of curing with UV radiation, as well, it is possible to operate under inert gas in order to prevent the formation of ozone.

Curing with actinic radiation is carried out using the customary and known radiation sources and optical auxiliary measures. Examples of suitable radiation sources are flashlights from the company VISIT, high-pressure or low-pressure mercury vapor lamps, with or without lead doping in order to open a radiation window of up to 405 nm, or electron beam sources. The arrangement of these sources is known in principle and may be adapted to the circumstances of the workpiece and the process parameters.

The above-described curing methods may of course also be employed in connection with the abovementioned other coating films.

If two or more coating materials are applied in the context of the process of the invention, this is carried out in an appropriately configured line, in which two or more application and, optionally, curing stations are interposed in series. Alternatively, following the application and curing of the first coating material, the coated strip is wound up again, after which the coated coil is provided in a second, third, etc. coil coating line with second, third, etc. coatings.

Following the production of the coated strips by the process of the invention, they can be wound up into coated coils and then processed further at another place; alternatively, they may be processed further as they come directly from the coil coating operation. For instance, they may be laminated with plastics or provided with removable protective films. After cutting into appropriately sized parts, they may be shaped. Examples of suitable shaping methods are pressing and deep drawing.

The resultant shaped parts are scratch resistant, corrosion stable, weathering stable and chemically stable and have an extremely good overall appearance, especially as regards gloss, color, and/or optical effects. They are therefore particularly suitable for applications in automotive construction, for example, for the production of bodywork parts and bodies, commercial vehicle bodies, and trailer paneling; in the household segment, for example, for the production of washing machines, dishwashers, dryers, refrigerators, freezers or ovens; in the lighting segment for the production of lamps for the interior and exterior; or in the interior and exterior building segment, for example, for the production of ceiling and wall elements, doors, gates, pipe insulation, shutters, or window profiles.

Both the pigmented powder slurry and the powder slurry clearcoat (unpigmented, powder slurry) that are used in the above-described process of the invention comprise at least one finely divided dimensionally stable constituent, i.e., a powder coating material, as the. disperse phase, and an aqueous medium as the continuous phase.

The finely divided dimensionally stable constituent or powder coating material may be solid and/or highly viscous. In the context of the present invention, “highly viscous” means that the particles behave essentially as solid particles under the conventional conditions of the preparation, storage and use of powder slurries or powder coating materials. The powder coating material is preferably solid.

Furthermore, the individual particles of the finely divided constituent or powder coating material are dimensionally stable. In the context of the present invention, “dimensionally stable” means that under the customary and known conditions of the storage and use of powder slurries and powder coating materials the particles agglomerate and/or break down into smaller particles only to a small extent, if at all, but essentially retain their original form even under the influence of shear forces.

The solids content of the pigmented powder slurries and the powder slurry clearcoats is preferably from 10 to 80, more preferably from 15 to 75, with particular preference from 20 to 70, with very particular preference from 25 to 70, and in particular from 30 to 65% by weight, based in each case on the pigmented powder slurry or the powder slurry clearcoat.

The average particle size of the finely divided dimensionally stable constituents of the pigmented powder slurries and the powder slurry clearcoats is preferably from 0.8 to 40 μm, more preferably from 0.8 to 20, μm, and with particular preference from 2 to 6 μm. By average particle size is meant the 50% median value determined by the laser diffraction method, i.e., 50% of the particles have a particle diameter ≦ the median value and 50% of the particles have a particle diameter ≧ the median value. In general, the particle size of the finely divided dimensionally stable constituents reaches its upper limit when owing to their size the particles are no longer able to flow out completely on baking, with the consequence of an adverse effect on film leveling. 40 μm is considered a sensible upper limit, since above this particle size blockage of the rinsing tubes of the highly sensitive application apparatus is to be expected.

Pigmented powder slurries and powder slurry clearcoats with average particle sizes of this kind possess better application properties and, at the applied film thicknesses of >30 μm as currently practiced in the automotive industry for the OEM finishing of automobiles, surprisingly exhibit a significantly reduced tendency toward popping and mudcracking than conventional combinations of surfacer, basecoat, and clearcoat.

The pigmented powder slurries and powder slurry clearcoats are preferably free from organic solvents (cosolvents). In the context of the present invention, this means that they have a residual volatile solvent content of <2.0% by weight, preferably <1.5% by weight and with particular preference <1.0% by weight. In accordance with the invention, it is especially advantageous if the residual content is situated below the gas-chromatographic detection limit.

The pigmented powder slurries and powder slurry clearcoats may be curable physically or thermally and/or with actinic radiation. The thermally curable powder slurries may in turn be self-crosslinking or externally crosslinking.

The pigmented powder slurries and the powder slurry clearcoats comprise at least one binder.

The binders are oligomeric and polymeric resins.

In accordance with the invention it is of advantage if the minimum film-forming temperature of the binders is at least 0° C., preferably at least 10, with particular preference at least 15, with very particular preference at least 20, and, in particular, at least 25° C. The minimum film-forming temperature can be determined by drawing down an aqueous dispersion of the binder onto a glass plate using a coating bar or applying a finely divided binder powder to a glass plate and heating it in a gradient oven. The temperature at which the pulverulent layer films is referred to as the minimum film-forming temperature. For further details reference is made to Römpp Lexikon Lacke und Druckfarben, Georg Thieme Verlag, Stuttgart, New York, 1998, “Minimum film-forming temperature”, page 391.

Examples of suitable binders are random, alternating and/or block addition (co)polymers of linear and/or branched and/or comblike construction of ethylenically unsaturated monomers, or polyaddition resins and/or polycondensation resins. For further details of these terms reference is made to Römpp Lexikon Lacke und Druckfarben, Georg Thieme Verlag, Stuttgart, New York, 1998, page 457, “Polyaddition” and “Polyaddition resins (polyadducts)”, and pages 463 and 464, “Poly-condensates”, “Polycondensation” and “Polycondensation resins”, and also pages 73 and 74, “Binders”.

Examples of suitable addition (co)polymers are (meth)acrylate (co)polymers or partially hydrolyzed polyvinyl esters, especially (meth)acrylate copolymers.

Examples of suitable polyaddition resins and/or polycondensation resins are polyesters, alkyds, poly-urethanes, polylactones, polycarbonates, polyethers, epoxy resin-amine adducts, polyureas, polyamides, polyimides, polyester-polyurethanes, polyether-poly-urethanes or polyester-polyether-polyurethanes, especially polyester-polyurethanes.

Of these binders, the (meth)acrylate (co)polymers have advantages and are therefore used with frequency.

The self-crosslinking binders of the thermally curable powder slurries and of the dual-cure powder slurries comprise reactive functional groups which are able to enter into crosslinking reactions with groups of their type or with complementary reactive functional groups. The externally crosslinking binders comprise reactive functional groups which are able to enter into crosslinking reactions with complementary reactive functional groups present in crosslinking agents (cf. also Römpp Lexikon Lacke und Druckfarben, Georg Thieme Verlag, Stuttgart, New York, 1998, “Curing”, pages 274 to 276, in particular page 275). Examples of suitable complementary reactive functional groups for use in accordance with the invention are summarized in the following overview. In the overview, the variable R is an acyclic or cyclic aliphatic, an aromatic, and/or an aromatic-aliphatic (araliphatic) radical; the variables R′ and R″ are identical or different aliphatic radicals or are linked to one another to form an aliphatic or heteroaliphatic ring.

Overview: Examples of Complementary Functional Groups

| | | |
|---|---|---|
| Binder | and | crosslinking agent |
| | or | |
| Crosslinking agent | and | binder |

| | |
|---|---|
| —SH | —C(O)—OH |
| —NH₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—OR |
| | —NH—CH₂—OR |
| | —NH—CH₂—OH |
| | —N(—CH₂—OR)₂ |
| | —NH—C(O)—CH(—C(O)OR)₂ |
| | —NH—C(O)—CH(—C(O)OR)(—C(O)—R) |
| | —NH—C(O)—NR′R″ |
| | >Si(OR)₂ |
| | 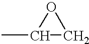 |
| | 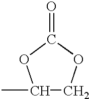 |
| —C(O)—OH | 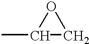 |
| | —N═C═N— |
| | —C(O)—N(CH₂—CH₂—OH)₂ |

The selection of the complementary groups in each case is guided firstly by the fact that during the preparation, storage, application, and melting of the powder slurries of the invention they should not enter into any unwanted reactions, in particular no premature crosslinking, and/or, if appropriate, should not disrupt or inhibit curing with actinic radiation, and secondly by the temperature range within which crosslinking is to take place. In the case of the pigmented powder slurries and the powder slurry clearcoats it is preferred to employ crosslinking temperatures of up to 250° C. Use is therefore made preferably of thio, hydroxyl, N-methylolamino, N-alkoxymethylamino, imino, carbamate, allophanate and/or carboxyl groups, preferably hydroxyl or carboxyl groups, on the one hand, and preferably crosslinking agents containing anhydride, carboxyl, epoxy, blocked isocyanate, urethane, methylol, methylol ether, siloxane, carbonate, amino, hydroxyl and/or beta-hydroxyalkylamide groups, preferably epoxy, beta-hydroxyalkylamide, blocked isocyanate, urethane or alkoxymethylamino groups, on the other.

In the case of self-crosslinking powder slurries, the binders contain in particular methylol, methylol ether and/or N-alkoxymethylamino groups.

Complementary reactive functional groups especially suitable for use in the externally crosslinking powder slurries are

carboxyl groups on the one hand and epoxide groups and/or beta-hydroxyalkylamide groups on the other, and

hydroxyl groups on the one hand and blocked isocyanate, urethane or alkoxymethylamino groups on the other.

The functionality of the binders in respect of the reactive functional groups described above may vary very widely and depends in particular on the desired crosslinking density and/or on the functionality of the crosslinking agents employed in each case. In the case of carboxyl-containing binders, for example, the acid number is preferably from 10 to 100, more preferably from 15 to 80, with particular preference from 20 to 75, with very particular preference from 25 to 70, and, in particular, from 30 to 65 mg KOH/g. Alternatively, in the case of hydroxyl-containing binders, the OH number is preferably from 15 to 300, more preferably from 20 to 250, with particular preference from 25 to 200, with very particular. preference from 30 to 150, and in particular from 35 to 120 mg KOH/g. Alternatively, in the case of binders containing epoxide groups, the epoxide equivalent weight is preferably from 400 to 2500, more preferably from 420 to 2200, with particular preference from 430 to 2100, with very particular preference from 440 to 2000, and, in particular, from 440 to 1900.

The complementary functional groups described above can be incorporated into the binders in accordance with the customary and known methods of polymer chemistry. This can be done, for example, by incorporating monomers which carry the corresponding reactive functional groups, and/or with the aid of polymer-analogous reactions.

Examples of suitable olefinically unsaturated monomers containing reactive functional groups are

(a1) monomers which carry at least one hydroxyl, amino, alkoxymethylamino, carbamate, allophanate or imino group per molecule, such as

hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxy-propyl, 3-hydroxybutyl, 4-hydroxybutyl acrylate, methacrylate, ethacrylate, crotonate, maleate, fumarate or itaconate; or hydroxy-cycloalkyl esters such as 1,4-bis(hydroxy-methyl)cyclohexane, octahydro-4,7-methano-1H-indenedimethanol or methylpropanediol mono-acrylate, monomethacrylate, monoethacrylate, monocrotonate, monomaleate, monofumarate or monoitaconate; reaction products of cyclic esters, such as epsilon-caprolactone and these hydroxyalkyl or hydroxycycloalkyl esters;

olefinically unsaturated alcohols such as allyl alcohol;

polyols such as trimethylolpropane monoallyl or diallyl ether or pentaerythritol monoallyl, diallyl or triallyl ether;

reaction products of acrylic acid and/or methacrylic acid with the glycidyl ester of an alpha-branched monocarboxylic acid having 5 to 18 carbon atoms per molecule, especially a Versatic® acid, or instead of the reaction product an equivalent amount of acrylic and/or methacrylic acid, which is then reacted during or after the polymerization reaction with the glycidyl ester of an alpha-branched mono-carboxylic acid having 5 to 18 carbon atoms per molecule, especially a Versatic® acid;

aminoethyl acrylate, aminoethyl methacrylate, allylamine or N-methyliminoethyl acrylate;

N,N-di(methoxymethyl)aminoethyl acrylate or methacrylate or N,N-di(butoxymethyl)aminopropyl acrylate or methacrylate;

(meth)acrylamides such as (meth)acrylamide, N-methyl-, N-methylol-, N,N-dimethylol-, N-methoxymethyl-, N,N-di (methoxymethyl) -, N-ethoxymethyl- and/or N,N-di (ethoxyethyl) -(meth)acrylamide;

acryloyloxy- or methacryloyloxyethyl, -propyl or -butyl carbamate or allophanate; further examples of suitable monomers containing carbamate groups are described in the patents U.S. Pat. No. 3,479,328 A1, U.S. Pat. No. 3,674,838 A1, U.S. Pat. No. 4,126,747 A1, U.S. Pat. No. 4,279,833 A1 or U.S. Pat. No. 4,340,497 A1;

(a2) monomers which carry at least one acid group per molecule, such as

acrylic acid, methacrylic acid, ethacrylic acid, crotonic acid, maleic acid, fumaric acid or itaconic acid;

olefinically unsaturated sulfonic or phosphonic acids or their partial esters;

mono(meth)acryloyloxyethyl maleate, succinate or phthalate; or

vinylbenzoic acid (all isomers), alpha-methylvinylbenzoic acid (all isomers) or vinylbenzenesulfonic acid (all isomers).

(a3) Monomers containing epoxide groups, such as the glycidyl ester of acrylic acid, methacrylic acid, ethacrylic acid, crotonic acid, maleic acid, fumaric acid or itaconic acid, or allyl glycidyl ether.

They are preferably used to prepare (meth)acrylate copolymers, especially the ones containing glycidyl groups.

Higher-functional monomers of the type described above are generally used in minor amounts. For the purposes of the present invention, minor amounts of higher-functional monomers are those amounts which do not lead to crosslinking or gelling of the copolymers, in particular of the (meth)acrylate copolymers, unless the specific desire is to prepare crosslinked polymeric microparticles.

Examples of suitable monomer units for introducing reactive functional groups into polyesters or polyester-polyurethanes are 2,2-dimethylolethyl- or -propylamine blocked with a ketone, the resulting ketoxime group being hydrolyzed again following incorporation; or compounds containing two hydroxyl groups or two primary and/or secondary amino groups and also at least one acid group, in particular at least one carboxyl group and/or at least one sulfonic acid group, such as dihydroxypropionic acid, dihydroxy-succinic acid, dihydroxybenzoic acid, 2,2-dimethylolacetic acid, 2,2-dimethylolpropionic acid, 2,2-dimethylolbutyric acid, 2,2-dimethylol-pentanoic acid, α, δ-diaminovaleric acid, 3,4-diamino-benzoic acid, 2,4-diaminotoluenesulfonic acid or 2,4-diaminodiphenyl ether sulfonic acid.

One example of introducing reactive functional groups by way of polymer-analogous reactions is the reaction of hydroxyl-containing resins with phosgene, resulting in resins containing chloroformate groups, and the polymer-analogous reaction of the chloroformate groups with ammonia and/or primary and/or secondary amines to give resins containing carbamate groups. Further examples of suitable methods of this kind are known from the patents U.S. Pat. No. 4,758,632 A1, U.S. Pat. No. 4,301,257 A1 or U.S. Pat. No. 2,979,514 A1.

The binders of the dual-cure powder slurries and the powder slurries curable purely with actinic radiation further comprise on average at least one, preferably at least two, group(s) having at least one bond per molecule that can be activated with actinic radiation.

For the purposes of the present invention, a bond that can be activated with actinic radiation is a bond which on exposure to actinic radiation becomes reactive and, with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as double bonds.

Accordingly, the group which is preferred in accordance with the invention comprises one double bond or two, three or four double bonds. If more than one double bond is used, the double bonds can be conjugated. In accordance with the invention, however, it is of advantage if the double bonds a-re present in isolation, in particular each being present terminally, in the group in question. It is of particular advantage in accordance with the invention to use two double bonds or, in particular, one double bond.

The dual-cure binders and the binders curable with actinic radiation comprise on average at least one of the above-described groups that can be activated with actinic radiation. This means that the functionality of the binders in this respect is integral, i.e., for example, is two, three, four, five or more, or nonintegral, i.e., for example, is from 2.1 to 10.5 or more. The functionality chosen depends on the requirements imposed on the respective dual-cure powder slurry or the respective powder slurry curable with actinic radiation.

If more than one group that can be activated with actinic radiation is used on average per molecule, the groups are structurally different from one another or of the same structure.

If they are structurally different from one another, this means, in the context of the present invention, that use is made of two, three, four or more, but especially two, groups that can be activated with actinic radiation, these groups deriving from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclo-pentadienyl, norbornenyl, isoprenyl, isopropenyl, allyl or butenyl ether groups; or dicyclopentadienyl, norbornenyl, isoprenyl, isopropenyl, allyl or butenyl ester groups, but especially acrylate groups.

Preferably, the groups are attached to the respective parent structures of the binders via urethane, urea, allophanate, ester, ether and/or amide groups, but in particular via ester groups. Normally, this occurs as a result of customary and known polymer-analogous reactions such as, for instance, the reaction of pendant glycidyl groups with the olefinically unsaturated monomers described above that contain an acid group, of pendant hydroxyl groups with the halides of these monomers, of hydroxyl groups with isocyanates containing double bonds such as vinyl isocyanate, methacryloyl isocyanate and/or 1-(l-isocyanato-1-methylethyl)-3-(1-methylethenyl)benzene (TMI® from CYTEC), or of isocyanate groups with the above-described hydroxyl-containing monomers.

Alternatively, in the dual-cure powder slurries, it is possible to employ mixtures of purely thermally curable binders and binders that are curable purely with actinic radiation.

The material composition of the binders has basically no special features; rather, suitable binders include

all the binders envisaged for use in powder slurry clearcoats curable thermally or thermally and with actinic radiation that are described in U.S. Pat. No. 4,268,542 A1 or U.S. Pat. No. 5,379,947 A1 and in patent applications DE 27 10 421 A1, DE 195 40 977 A1, DE 195 18 392 A1, DE 196 17 086 A1, DE 196 13 547 A1, DE 196 18 657 A1, DE 196 52 813 A1, DE 196 17 086 A1, DE 198 14 471 A1, DE 198 41 842 A1 or DE 198 41 408 A1, in German Patent Applications DE 199 08 018.6 or DE 199 08 013.5, unpublished at the priority date of the present specification, or in European Patent EP 0 652 264 A1;

all the binders envisaged for use in dual-cure clearcoats that are described in patent applications DE 198 35 296 A1, DE 197 36 083 A1 or DE 198 41 842 A1; or

all the binders envisaged for use in thermally curable powder clearcoats and described in German Patent Application DE 42 22 194 A1, in the product information bulletin from BASF Lacke+Farben A G, “Pulverlacke” [Powder coatings], 1990, or in the BASF Coatings AG brochure “Pulverlacke, Pulverlacke für industrielle Anwendungen” [Powder coating materials, powder coatings for industrial applications], January 2000.

In this context, (meth)acrylate addition copolymers are used predominantly for the powder coating materials and powder slurries that are curable thermally or thermally and with actinic radiation.

Examples of suitable (meth)acrylate copolymers are the (meth)acrylate copolymers containing epoxide groups, having an epoxide equivalent weight of preferably from 400 to 2500, more preferably from 420 to 2200, with particular preference from 430 to 2100, with very particular preference from 440 to 2000, and, in particular, from 440 to 1900, a number-average molecular weight (determined by gel permeation chromatography using a polystyrene standard) of preferably from 2000 to 20,000 and in particular from 3000 to 10,000, and a glass transition temperature (Tg) of preferably from 30 to 80, more preferably from 40 to 70 and in particular from 40 to 60° C. (measured by means of differential scanning calorimetry (DSC)), as suitable in particular for use in thermally curable powder clearcoat slurries (see above) and as described, furthermore, in the patents and patent applications EP 0 299 420 A1, DE 22 14 650 B1, DE 27 49 576 B1, U.S. Pat. No. 4,091,048 A1 or U.S. Pat. No. 3,781,379 A1.

Suitable additional binders for the dual-cure powder slurries, or suitable sole binders for the powder slurries that are curable purely with actinic radiation, are the binders envisaged for use in UV-curable clearcoats, powder clearcoats and powder slurry clearcoats and described in European Patent Applications EP 0 928 800 A1, EP 0 636 669 A1, EP 0 410 242 A1, EP 0 783 534 A1, EP 0 650 978 A1, EP 0 650 979 A1, EP 0 650 985 A1, EP 0 540 884 A1, EP 0 568 967 A1, EP 0 054 505 A1 or EP 0 002 866 A1, in German Patent Applications DE 198 35 206 A1, DE 197 09 467 A1, DE 42 03 278 A1, DE 33 16 593 A1, DE 38 36 370 A1, DE 24 36 186 A1 or DE 20 03 579 B1, in the International Patent Applications WO 97/46549 or WO 99/14254, or in U.S. Patents U.S. Pat. No. 5,824,373 A1, U.S. Pat. No. 4,675,234 A1, U.S. Pat. No. 4,634,602 A1, U.S. Pat. No. 4,424,252 A1, U.S. Pat. No. 4,208,313 A1, U.S. Pat. No. 4,163,810 A1, U.S. Pat. No. 4,129,488 A1, U.S. Pat. No. 4,064,161 A1 or U.S. Pat. No. 3,974,303 A1.

The preparation of the binders also has no special features as to its method, but takes place with the aid of the customary and known methods of polymer chemistry, as described in detail, for example, in the patent documents recited above.

Further examples of suitable preparation processes for (meth)acrylate copolymers are described in European Patent Application EP 0 767 185 A1, in German Patents DE 22 14 650 B1 or DE 27 49 576B1, and in U.S. Patents U.S. Pat. No. 4,091,048 A1, U.S. Pat. No. 3,781,379 A1, U.S. Pat. No. 5,480,493 A1, U.S. Pat. No. 5,475,073 A1 or U.S. Pat. No. 5,534,598 A1, or in the standard work Houben-Weyl, Methoden der organischen Chemie, 4^{th} Edition, Volume 14/1, pages. 24 to 255, 1961. Suitable reactors for the copolymerization are the customary and known stirred vessels, cascades of stirred vessels, tube reactors, loop reactors or Taylor reactors, as described, for example, in the patents and patent applications DE 1 071 241 B1, EP 0 498 583 A1 or DE 198 28 742 A1 or in the article by K. Kataoka in Chemical Engineering Science, Volume 50, No. 9, 1995, pages 1409 to 1416.

The preparation of polyesters and alkyd resins is also described, for example, in the standard work Ullmanns Encyklopädie der technischen Chemie, 3^{rd} Edition, Volume 14, Urban & Schwarzenberg, Munich, Berlin, 1963, pages 80 to 89 and pages 99 to 105, and also in the following books: “Résines Alkydes-Polyesters” by J. Bourry, Paris, Dunod, 1952, “Alkyd Resins” by C. R. Martens, Reinhold Publishing Corporation, New York, 1961, and “Alkyd Resin Technology” by T. C. Patton, Interscience Publishers, 1962.

The preparation of polyurethanes and/or acrylated polyurethanes is also described, for example, in the patent applications EP 0 708 788 A1, DE 44 0l 544 A1 or DE 195 34 361 A1.

The binder content of the disperse phase of the pigmented powder slurries and of the powder slurry clearcoats may vary very widely and depends in particular on whether they are physically or thermally self-crosslinking and/or pigmented.

In the case of the unpigmented powder slurry clearcoats curable physically, with thermal self-crosslinking or with actinic radiation, the content may be up to 100% by weight. In the case of the pigmented powder slurries curable physically, with thermal self-crosslinking or with actinic radiation, the content described below, of color and/or effect pigments, is to be taken into account.

In the other cases (pigmented and unpigmented, externally crosslinking powder slurries curable thermally or thermally and with actinic radiation), the binder content is preferably from 10 to 80, more preferably from 15 to 75, with particular preference from 20 to 70, with very particular preference from 25 to 65, and in particular from 30 to 60% by weight, based in each case on the solids content of the powder slurry.

The externally. crosslinking pigmented and unpigmented powder slurries curable thermally, or thermally and with actinic radiation, comprise at least one crosslinking agent which comprises the reactive functional groups complementary to the reactive functional groups of the binders. Consequently, the skilled worker is easily able to select the crosslinking agents suitable for a given powder slurry.

Examples of suitable crosslinking agents are

amino resins, as described for example in Römpp Lexikon Lacke und Druckfarben, Georg Thieme Verlag, 1998, page 29, “Amino resins”, in the textbook “Lackadditive”by Johan Bieleman, Wiley-VCH, Weinheim, New York, 1998, pages 242 ff., in the book “Paints, Coatings and Solvents”, second completely revised edition, Eds. D. Stoye and W. Freitag, Wiley-VCH, Weinheim, New York, 1998, pages 80 ff., in patents U.S. Pat. No. 4,710,542 A1 or EP 0 245 700 A1, and in the article by B. Singh and coworkers “Carbamylmethylated Melamines, Novel Crosslinkers for the Coatings Industry” in Advanced Organic Coatings Science and Technology Series, 1991, Volume 13, pages 193 to 207;

carboxyl-containing compounds or resins, as described, for example, in the patent DE 196 52 813 A1 or 198 41 408 A1, especially dodecanedioic acid;

epoxy-containing compounds-or resins, as described for example in patents EP 0 299 420 A1, DE 22 14 650 B1, DE 27 49 576 B1, U.S. Pat. No. 4,091,048 A1 or U.S. Pat. No. 3,781,379 A1;

blocked polyisocyanates, as described, for example, in the patents U.S. Pat. No. 4,444,954 A1, DE 196 17 086 A1, DE 196 31 269 A1, EP 0 004 571 A1 or EP 0 582 051 A1;

beta-hydroxyalkylamides such as N,N,N′,N′-tetrakis (2-hydroxyethyl)adipamide or N,N,N′,N′-tetrakis (2-hydroxypropyl)adipamide; and/or

tris(alkoxycarbonylamino)triazines, as described in patents U.S. Pat. No. 4,939,213 A1, U.S. Pat. No. 5,084,541 A1, U.S. Pat. No. 5,288,865 A1 or EP 0 604 922 A1.

The crosslinking agent content of the powder slurries may likewise vary very widely and depends on the requirements of the individual case, in particular on the number of reactive functional groups present. It is preferably from 1.0 to 40, more preferably from 2.0 to 35, with particular preference from 3.0 to 30, with very particular preference from 4.0 to 27, and in particular from 5.0 to 25% by weight, based in each case on the solids content of the powder slurry.

The pigmented powder slurries comprise at least one color and/or effect pigment, in particular at least one effect pigment.

Regarding the term effect pigments, reference is made to Römpp Lexikon Lacke und Druckfarben, Georg Thieme Verlag, 1998, pages 176, “Effect pigments”, and pages 380 and 381, “Metal oxide-mica pigments” to “Metal pigments”. Accordingly, suitable effect pigments include metal flake pigments such as commercial aluminum bronzes, aluminum bronzes chromated in accordance with DE-A-36 36 183, commercial stainless steel bronzes, and metal and nonmetal effect pigments, such as pearlescent pigments and interference pigments, for example. Particular preference is given to metal effect pigments, especially aluminum effect pigments.

The effect pigment may have a broad or a narrow particle size distribution.

The determination is carried out as described above by the laser diffraction method (cf. Römpp Lexikon Lacke und Druckfarben, Georg Thieme Verlag, 1998, page 349, “Laser diffraction”), by sieve analysis (cf. Römpp Lexikon Lacke und Druckfarben, Georg Thieme Verlag, 1998, page 521, “Sieve analysis”) in accordance with DIN 66165-1 or -2: 1987-04 or DIN 66160:1990-02, by sedimentation analysis in accordance with DIN 66115-2: 1983-02 with the aid of the pipette process or of the sedigraph, or by screen analysis in accordance with DIN 66118:1984-04 (cf. Römpp Lexikon Lacke und Druckfarben, Georg Thieme Verlag, 1998, page 521, “Screen analysis”).

In the context of the present invention, the term “broad particle size distribution” indicates that the effect pigment in question has a comparatively large fine fraction, i.e., pigment particles with a particle size in the range from 1 to 10 μm, and a comparatively large coarse fraction with a particle size in the range from 70 to 90 μm. This results in a particularly flat slope of the cumulative particle distribution curve.

The effect pigments may also be leafing effect pigments with a broad or narrow particle size distribution. Leafing pigments are pigments which float in films of pigmented coating materials. In accordance with DIN 55945 (December 1988), this refers to the accumulation of pigments at the surface of a coating material (cf. Römpp Lexikon Lacke und Druckfarben, Georg Thieme Verlag, 1998, page 351, “Leafing pigments”).

Furthermore, they may be coated with optically transparent, thermoplastic oligomers and polymers. Oligomers are resins containing at least 2 to 15 monomer units in their molecule. Polymers are resins containing at least 10 monomer units in their molecule. For further details of these terms, reference is made to Römpp Lexikon Lacke und Druckfarben, Georg Thieme Verlag, Stuttgart, New York, 1998, “Oligomers”, page 425.

Examples of suitable oligomers and polymers are linear and/or branched and/or block, comb and/or random polyaddition resins, polycondensation resins and/or addition (co)polymers of ethylenically unsaturated monomers.

Examples of suitable addition (co)polymers are (meth)acrylate (co)polymers and/or polystyrene, polyvinyl esters, polyvinyl ethers, polyvinyl halides, polyvinyl amides, polyacrylonitriles, polyethylenes, polypropylenes, polybutylenes, polyisoprenes and/or copolymers thereof.

Examples of suitable polyaddition resins or polycondensation resins are polyesters, alkyds, polylactones, polycarbonates, polyethers, epoxy resin-amine adducts, polyurethanes and/or polyureas.

Furthermore, the effect pigments may have been hydrophilicized. This is preferably carried out by pasting with a nonionic surfactant (cf. Römpp Lexikon Lacke und Druckfarben, Georg Thieme Verlag, 1998, page 410, “Nonionic surfactants”).

In a first embodiment which is preferred in accordance with the invention, the finely divided dimensionally stable constituents of the pigmented powder slurries comprise all of the effect pigments used.

In a second embodiment which is preferred in accordance with the invention, the finely divided dimensionally stable constituents of the pigmented powder slurries contain no effect pigments; i.e., all of the effect pigments used are present in the form of a separate, solid phase.

In a third embodiment preferred in accordance with the invention, the finely divided dimensionally stable constituents of the pigmented powder slurries comprise some of the effect pigments used, the remainder being present in the form of a separate solid phase. In this case, the fraction present in the finely divided dimensionally stable constituents may comprise the majority, i.e., more than 50%, of the coated effect pigments used. However, it is also possible for less than 50% to be situated within the finely divided dimensionally stable constituents.

Which variant of the pigmented powder slurries is given preference depends in particular on the nature of the effect pigments and/or on the process by which the pigmented powder slurries used in each case are prepared. In many cases, the third preferred embodiment offers particular advantages, and so is particularly preferred in accordance with the invention.

The effect pigment content of the pigmented powder slurries may vary very widely and depends on the requirements of each individual case, in particular on the optical effect to be established and/or the hiding power of the coated effect pigments used in each case. Preferably, the effect pigment content is from 0.1 to 20, more preferably from 0.3 to 18, with particular preference from 0.5 to 16, with very particular preference from 0.7 to 14, and in particular from 0.9 to 12% by weight, based in each case on the solids content of the powder slurry.

In addition to the effect pigments, the pigmented powder slurries may comprise further customary and known color pigments.

These pigments may comprise organic or inorganic compounds. Because of this large number of suitable pigments, therefore, the pigmented powder slurries ensure universality in their breadth of use and enable the realization of a large number of particularly attractive color shades and optical effects.

Examples of suitable inorganic color pigments are titanium dioxide, iron oxides, and carbon black. Examples of suitable organic color pigments are thioindigo pigments, indanthrene blue, Irgalith blue, Heliogen blue, Irgazine blue, Palomar blue, Cromophthal red, Hostaperm pink, Irgazine orange, Sicotrans yellow, Sicotan yellow, Hostaperm yellow, Paliotan yellow, and Heliogen green.

For further details, reference is made to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, and page 567, “Titanium dioxide pigments”.

As described above in connection with the effect pigments, the pigments may be present inside and outside the finely divided dimensionally stable constituents of the pigmented powder slurries. As far as the particle sizes are concerned, the comments made above apply analogously here as well.

The pigmented powder slurries may further comprise organic and inorganic fillers, which like the pigments may be present within and outside the finely divided dimensionally stable constituents; the comments made with regard to the pigments apply analogously here.

Examples of suitable organic and inorganic fillers are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers, polyacrylonitrile powders, polyamide powders, or wood flour. For further details, reference is made to Römpp Lexikon Lacke und Druckfarben, Georg Thieme verlag, 1998, pages 250 ff., “Fillers”. Further examples of suitable fillers are disclosed in German Patent Application DE 196 06 706 A1, column 8, lines 30 to 64. They are preferably used in the amounts specified therein.

The pigments and fillers may also be present in an ultrafine, nonhiding form.

The proportion of the pigments, fillers and effect pigments in the pigmented powder slurries may vary very widely and depends on the requirements of the specific case, in particular on the optical effect to be established and/or on the hiding power of the particular pigments used. Preferably, the amount of pigments, fillers and effect pigments is from 1.0 to 80, more preferably from 2.0 to 75, with particular preference from 3.0 to 70, with very particular preference from 4.0 to 65, and in particular from 5.0 to 60% by weight, based in each case on the solids content of the powder slurry.

In addition to the pigments and/or fillers described above, or instead of them, the pigmented powder slurries may comprise organic dyes in molecularly disperse distribution.

These dyes in molecularly disperse distribution are present in the finely divided dimensionally stable constituents of the powder coating materials.

In the pigmented powder slurries, they may be present either in the dispersed, finely divided dimensionally stable constituents or in the continuous phase of the pigmented powder slurries.

Alternatively, they may be present in the dispersed finely divided dimensionally stable constituents and in the continuous phase. In this case, the fraction present in the finely divided dimensionally stable constituents may comprise the majority, i.e., more than 50%, of the organic dyes used. Alternatively, less than 50% may be present therein. The distribution of the organic dyes between the phases may correspond to the thermodynamic equilibrium that results from the solubility of the organic dyes in the phases. The distribution may, however, also be far removed from the thermodynamic equilibrium.

Suitable organic dyes are all those which are soluble in the pigmented powder slurries in the sense depicted above. Lightfast organic dyes are highly suitable. Particularly suitable lightfast organic dyes are those having little or no tendency to migrate. The migration tendency can be estimated by the skilled worker on the basis of his or her general knowledge in the art and/or determined with the aid of simple preliminary rangefinding tests, for example, in tinting experiments.

The amount of organic dyes in molecularly disperse distribution in the pigmented powder slurries may vary very widely and depends primarily on the color and on the shade to be established and also on the amount of any pigments and/or fillers present.

The pigmented and unpigmented powder slurries may further comprise at least one additive. Depending on its physicochemical properties and/or its function, said additive may be present essentially in the finely divided solid constituents of the powder slurries or essentially in the continuous phase.

Examples of suitable additives are

secondary or primary (meth)acrylate polymer dispersions;

thermally curable reactive diluents such as positionally isomeric diethyloctanediols or hydroxyl-containing hyperbranched compounds or dendrimers as described in German Patent Application DE 198 50 243 A1;

reactive diluents curable with actinic radiation, such as those described in Römpp Lexikon Lacke und Druckfarben, George Thieme Verlag, Stuttgart, New York, 1998, on page 491 under the headword “Reactive diluents”;

crosslinking catalysts such as dibutyltin dilaurate, lithium decanoate or zinc octoate, amine-blocked organic sulfonic acids, quaternary ammonium compounds, amines, imidazole and imidazole derivatives such as 2-styrylimidazole, 1-benzyl-2-methylimidazole, 2-methylimidazole and 2-butylimidazole, as described in Belgian Patent No. 756,693, or phosphonium catalysts such as ethyltriphenylphosphonium iodide, ethyltriphenyl-phosphonium chloride, ethyltriphenylphosphonium thiocyanate, ethyltriphenylphosphonium acetate-acetic acid complex, tetrabutylphosphonium iodide, tetrabutylphosphonium bromide and tetrabutyl-phosphonium acetate-acetic acid complex, as are described, for example, in U.S. Patents U.S. Pat. No. 3,477,990 A1 or U.S. Pat. No. 3,341,580 A1;

thermally labile free-radical initiators such as organic peroxides, organic azo compounds or C—C-cleaving initiators such as dialkyl peroxides, peroxocarboxylic acids; peroxodicarbonates, peroxide esters, hydroperoxides, ketone peroxides, azodinitriles or benzpinacol silyl ether;

photoinitiators, as described in Römpp Chemie Lexikon, 9^{th} expanded and revised edition, Georg Thieme Verlag, Stuttgart, Vol. 4, 1991, or in Römpp Lexikon Lacke und Druckfarben, Georg Thieme Verlag, Stuttgart, 1998, pages 444 to 446;

antioxidants such as hydrazines and phosphorus compounds;

UV absorbers such as triazines and benzotriphenol;

light stabilizers such as HALS compounds, benzotriazoles or oxalanilides;

leveling agents;

free-radical scavengers and polymerization inhibitors such as organic phosphites or 2,6-di-tert-butylphenol derivatives;

slip additives;

defoamers;

emulsifiers, especially nonionic emulsifiers such as alkoxylated alkanols and polyols, phenols and alkylphenols, anionic emulsifiers such as alkali metal salts or ammonium salts of alkanecarboxylic acids, alkanesulfonic acids, and sulfo acids of alkoxylated alkanols and polyols, phenols and alkylphenols;

wetting agents such as siloxanes, fluorine compounds, carboxylic monoesters, phosphoric esters, polyacrylic acids and their copolymers, or polyurethanes, as described, for example, in detail in patent application DE 198 35 296 A1, especially in conjunction with the polyurethane-based associative thickeners described below;

adhesion promoters such as tricyclodecanedi-methanol;

film-forming auxiliaries such as cellulose derivatives;

flame retardants;

devolatilizers such as diazadicycloundecane or benzoin;

water retention agents;

free-flow aids;

rheology control additives (thickeners), such as those known from patents WO 94/22968, EP 0 276 501 A1, EP 0 249 201 A1 or WO 97/12945; crosslinked polymeric microparticles, such as those disclosed, for example, in EP 0 008 127 A1; inorganic sheet silicates such as aluminum-magnesium silicates, sodium-magnesium and sodium-magnesium-fluorine-lithium sheet silicates of the montmorillonite type; silicas such as Aerosils; or synthetic polymers having ionic and/or associative groups, such as polyvinyl alcohol, poly(meth)-acrylamide, poly(meth)acrylic acid, polyvinyl-pyrrolidone, styrene-maleic anhydride copolymers or ethylene-maleic anhydride copolymers and their derivatives or polyacrylates; or polyurethane-based associative thickeners, as described in Römpp Lexikon Lacke und Druckfarben, Georg Thieme Verlag, Stuttgart, New York, 1998, “Thickeners”, pages 599 to 600, and in the textbook “Lackadditive” [Coatings additives] by Johan Bieleman, Wiley-VCH, Weinheim, New York, 1998, pages 51 to 59 and 65; but especially

combinations of ionic and nonionic thickeners, as described in patent application DE 198 41 842 A1 for establishing a pseudoplastic behavior, or

combinations of polyurethane-based associative thickeners and polyurethane-based wetting agents, as described in detail in German Patent Application DE 198 35 296 A1.

Further examples of suitable additives are described in the textbook “Lackadditive” by Johan Bieleman, Wiley-VCH, Weinheim, New York, 1998. They are employed in the customary and known amounts.

The preparation of the powder slurries also has no peculiarities in terms of its method, but instead takes place in accordance with customary and known processes.

In a first preferred variant, the powder slurries are prepared from the constituents described above essentially as described in detail in patent applications DE 195 40 977 A1, DE 195 18 392 A1, DE 196 17 086 A1, DE-A-196 13 547, DE 196 18 657 A1, DE 196 52 813 A1, DE 196 17 086 A1, DE-A-198 14 471 A1, DE 198 41 842 A1 or DE 198 41 408 A1, except that in the context of the present invention color and/or effect pigments may also be included in processing. In this case, the powder coating material is converted into the powder slurry by means of wet milling or by stirring dry-milled powder coating material into water or an aqueous medium. Particular preference is given to wet milling.

In another preferred variant of preparing the powder slurries, the constituents described above are emulsified in an organic solvent to give an emulsion of the oil-in-water type, after which the organic solvent is removed; as a result of this, the emulsified droplets solidify and the powder slurry results. The powder slurry may then be subjected to wet milling to enhance its filterability.

In a third preferred variant of preparing the powder slurries, a liquid melt of the constituents described above is introduced together if desired with the unmelted color and/or effect pigments into an emulsifying apparatus, preferably with the addition of water and stabilizers, and the emulsion obtained is cooled and filtered, giving the powder slurry. In order to achieve a high quality of mixing, it is essential to carry out mixing in the melt without solvent. Accordingly, the polymeric constituents are fed into the dispersing apparatus in the form of viscous resin melts.

Preferably, the resultant powder slurries are filtered after wet milling. This is done using the customary and known filtration equipment and filters, as also suitable for filtering known powder slurries. The mesh size of the filters may vary widely and depends primarily on the particle size and on the particle size distribution of the particles in the suspension. The skilled worker will therefore easily be able to determine the appropriate filters on the basis of this physical parameter. Examples of suitable filters are bag filters. These are available commercially under the brand names Pong® or Cuno®. It is preferred to use bag filters having mesh sizes from 10 to 50 μm, examples being Pong® 10 to Pong® 50.

### EXAMPLES

### Preparation Example 1

The Preparation of a Methacrylate Copolymer

21.1 parts of xylene were introduced into a vessel and heated to 130° C. At 130° C., initiator—4.5 parts of TBPEH (tert-butyl perethylhexanoate) mixed with 4.86 parts of xylene—and monomers—10.78 parts of methyl methacrylate, 25.5 parts of n-butyl methacrylate,. 17.39 parts of styrene and 23.95 parts of glycidyl methacrylate—were metered into the initial charge from two separate feed vessels over the course of 4 h. Subsequently, the batch was heated to 180° C. and the solvent was stripped off under a reduced pressure of <100 mbar.

### Preparation Example 2

The Preparation of the Powder Clearcoat

73.5 parts of methacrylate copolymer from Preparation Example 1, 17.8 parts of dodecanedioic acid, 5.0 parts of TACT® from Cytec (tris(alkoxycarbonylamino)-triazines), 2 parts of Tinuvin® 1130 (UV absorber), 0.9 part of Tinuvin® 144 (HALS), 0.4 part of Additol® XL 490 (leveling agent) and 0.4 part of benzoin (devolatilizer) were intimately mixed on a Henschel fluid mixer, the mixture was extruded on a BUSS PLK 46 extruder, and the extrudate was ground on a Hosokawa. ACM 2 mill and screened through a 125 μm sieve.

### Preparation Example 3

The Preparation of the Powder Slurry Clearcoat

0.6 part of Troykyd® D777 (defoamer), 0.6 part of Orotan® 731 K (dispersing aid), 0.06 part of Surfinol® TMN 6 (wetting agent) and 16.5 parts of RM8 (Rohm & Haas, nonionic associative thickener based on polyurethane) were dispersed in 400 parts of deionized water. Then, in small portions, 94 parts of the powder clearcoat from Preparation Example 2 were stirred in. Subsequently, a further 0.6 part of Troykyd® D777, 0.6 part of Orotan® 731 K, 0.06 part of Surfinol® TMN 6 and 16.5 parts of RM8 were incorporated by dispersion. Finally, in small portions, 94 parts of the powder clearcoat were stirred in. The material was milled in a sandmill for 3.5 h. The average particle size measured finally. is 4 μm. The material was filtered through a 50 μm filter and, finally, 0.05% of Byk® 345 (leveling agent) was added.

### EXAMPLE

The Coating of an Aluminum Strip with the Powder Slurry Clearcoat by the Process of the Invention

In a customary and known coil coating line, a cleaned and degreased aluminum strip with a thickness of 500 μm which had been provided on both sides with an oxide layer produced by anodic oxidation and passivated with phosphoric acid was coated on one side with the powder slurry clearcoat of Preparation Example 3 at a strip speed of 45 m/min.

For this purpose, the powder slurry clearcoat was picked up from a reservoir trough by a pick-up roll, which rotated at a peripheral speed of 13.5 m/min. At a narrow roll nip, the powder slurry clearcoat was transferred to the application roll. This roll rotated at a peripheral speed of 52 m/min and transferred the powder slurry clearcoat counter-directionally onto the aluminum strip. The wet film thickness of the powder slurry, clearcoat film was chosen so as to give, after curing, a dry film thickness of 12 μm.

The strip coated with the powder slurry clearcoat film, was passed to a convection oven with a length of approximately 40 m, in which the strip was heated in accordance with a temperature program up to a maximum strip temperature of 250° C., so that the water present in the powder slurry clearcoat film evaporated, the solid powder slurry clearcoat film melted and flowed, and cured in the melted state. The total curing process lasted just under 1 minute.

The clearcoat produced in the manner of the invention was smooth and highly transparent. Its gloss was 100 units at 60° C. It resisted more than 100 back-and-forth strokes with a cotton rag soaked with methyl ethyl ketone, without damage. The flexural strength (cf. Römpp Lexikon Lacke und Druckfarben, Georg Thieme Verlag, 1998, page 73, “Flexural strength”) and the bond strength were very good (T-bend test: T0; tape test: T0). The scratch resistance, as well, was very good (Erichsen scratch resistance: >40 N).

The aluminum strip coated with the clearcoat could be shaped without problems by deep drawing to give shaped parts such as window frames and lamp components.

What is claimed is:

1. A coil coating process in which a metal strip is coated continuously on one or two sides with at least one coating material and then the applied coating film(s) is (are) cured, wherein at least one of the coating materials is a pigmented or unpigmented powder coating dispersion (powder slurry) and the applied powder slurry film(s) is(are) heated so that
(i) the water present therein evaporates,
(ii) the finely divided dimensionally stable constituents of the powder slurry which remain melt and coalesce, and
(iii) curing is carried out thermally and/or with actinic radiation, to give at least one clearcoat and/or at least one color and/or effect coat.

2. The coating process as claimed in claim 1, wherein the applied powder slurry film(s) is(are) heated to 250° C.

3. The coating process as claimed in claim 1 or 2, wherein the melted or thermally cured powder slurry film(s) is(are) exposed to actinic radiation.

4. The coating process as claimed in any of claims 1 to 3, wherein curing is conducted within a period of from 10 s to 2 min.

5. The coating process as claimed in any of claims 1 to 3, wherein the powder slurry is applied by roller coating.

6. The coating process as claimed in claim 5, wherein application takes place by the reverse roller coating technique using from two to four rolls.

7. The coating process as claimed in claim 5 or 6, wherein the pick-up roll has a peripheral speed which is from 20 to 40% of the strip speed.

8. The coating process as claimed in any of claims 5 to 7, wherein the application roll has a peripheral speed which is from 110 to 125% of the strip speed.

9. The coating process as claimed in any of claims 1 to 8, wherein the powder slurry or slurries is or are
(i) applied directly to the strip and cured,
(ii) applied to at least one single-coat or multicoat system present on the strip, and cured, or
(iii) applied wet-on-wet to at least one single-coat or multicoat film present on the strip, and the coating film(s) and the powder slurry film(s) are cured conjointly,
or wherein
(iv) the cured or uncured powder slurry film(s) is (are) coated with at least one coating material, after which the resultant coating film(s) is(are) cured alone or together with the powder slurry film(s).

10. The coating process as claimed in claim 9, wherein the coating films and coatings already on the strip and/or the coating materials applied subsequently are pigmented and/or unpigmented powder slurries or are produced therefrom.
